(19) United States
(12) Patent Application Publication
(10) Pub. No.: US 2011/0108367 A1
(43) Pub. Date: May 12, 2011

(54) GUIDING APPARATUS OF CAR AND COUNTERWEIGHT OF ELEVATOR

(75) Inventors: Chia-Cheng Chiu, Taipei (TW); Mei-Sheng Chiu, Taipei (TW)

(73) Assignee: GOLDEN FRIENDS (GFC,LTD.) CORPORATION, Taipei (TW)

(21) Appl. No.: 12/910,509

(22) Filed: Oct. 22, 2010

(30) Foreign Application Priority Data
Nov. 10, 2009 (TW) 98220762
Apr. 21, 2010 (TW) 99207276
Apr. 28, 2010 (TW) 99207793

(51) Int. Cl. B66B 7/02; B66B 11/08

(52) U.S. Cl. 187/254

(57) ABSTRACT

An elevator includes a pair of vertical shafts, each of which have a vertical first rail and a vertical second rail; a car engaged with the first rails of the shafts that the car moves along the shafts; a counterweight engaged with the second rails of the shafts that the counterweight moves along the shafts; and a driving unit having ropes with opposite ends connected to the car and the counterweight to drive the car to move. The elevator of the present invention only has the shafts to guide both of the car and the counterweight that there may be more space for the car to provide a great capacity in the same hoistway.

### BACKGROUND OF THE INVENTION

1. Field of the Invention

The present invention relates generally to an elevator, and more particularly to an elevator which may be installed in a narrow hoistway with a low cost and a high capacity.

2. Description of the Related Art

Elevators are common equipment in modern buildings to transport people or goods to different floors. A conventional elevator includes a pair of car rails vertically mounted in a hoistway and a car engaged with the car rails. At a top of the hoistway is a machine room in which a traction machine, a governor and a plurality of pulleys are provided that the traction machine may lift or lower the car in the hoistway through ropes. The car rails usually are provided at opposite sides of the car, and the car is provided with two frames at a top and a bottom to be engaged with the car rails. For the movement of the car, a counterweight is provided with a weight about identical to the car plus an average load of the elevator. The counterweight is connected to the ropes and is engaged with a pair of counterweight rails behind the car that the counterweight moves up and down along the counterweight rails in an opposite direction to lift or lower the car.

In a conventional elevator system, there are four rails, for the car and the counterweight respectively, in the hoistway that the car must be much smaller than the hoistway because the rails take too much space. Furthermore, the conventional car usually is provided with one door because of the rails and the counterweight.

### SUMMARY OF THE INVENTION

The primary objective of the present invention is to provide an elevator which may be installed in a narrow hoistway with a low cost and a high capacity.

According to the objective of the present invention, an elevator includes a pair of vertical shaft, each of which have a vertical first rail and a vertical second rail; a car having guiding devices to be engaged with the first rails of the shafts that the car moves along the shafts; a counterweight having guiding devices to be engaged with the second rails of the shafts that the counterweight moves along the shafts; and a driving unit having ropes with opposite ends connected to the car and the counterweight to drive the car to move.

In a preferred embodiment, the elevator of the present invention only has one shaft having a vertical first rail and a vertical second rail. A car is engaged with the first rail of the shaft that the car moves along the shaft, and a counterweight is engaged with the second rail of the shaft that the counterweight moves along the shafts; and a driving unit has ropes with opposite ends connected to the car and the counterweight to drive the car to move.

### BRIEF DESCRIPTION OF THE DRAWINGS

FIG. 1 is a sketch diagram of a first preferred embodiment of the present invention;

FIG. 2 is a sketch diagram from a top of the first preferred embodiment of the present invention;

FIG. 3 is a sketch diagram from a back of the first preferred embodiment of the present invention;

FIG. 4 is a sketch diagram of a second preferred embodiment of the present invention;

FIG. 5 is a sketch diagram from a top of the second preferred embodiment of the present invention;

FIG. 6 is a sketch diagram of the second preferred embodiment of the present invention, showing the second rails shifting outwardly;

FIG. 7 is a sketch diagram of a third preferred embodiment of the present invention; and

FIG. 8 is a sketch diagram from a top of the third preferred embodiment of the present invention.

### DETAILED DESCRIPTION OF THE INVENTION

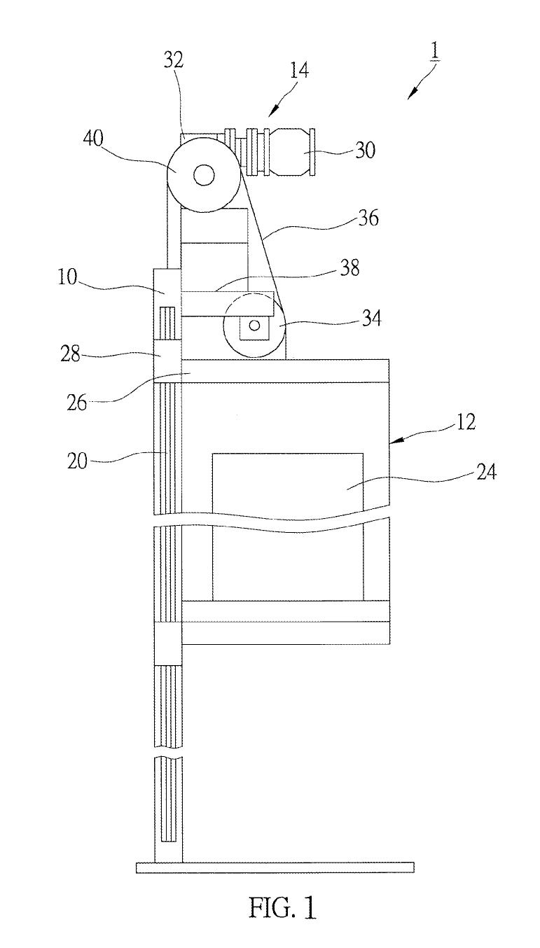

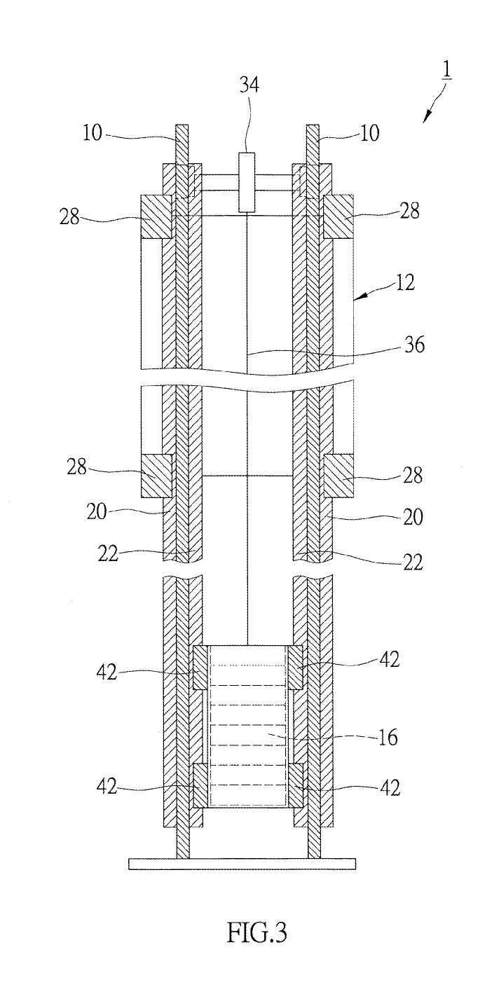

As shown in FIG. 1 to FIG. 3, an elevator 1 of the first preferred embodiment of the present invention includes a pair of shafts 10, a car 12, a driving unit 14, and a counterweight 16.

The shafts 10 are parallel and vertical mounted in a hoistway. Each of the shafts 10 has a first rail 20 and a second rail 22. The second rails 22 are provided at inner sides of the shafts 10 that the second rails 22 face each other, and the first rails 20 are provided at outer sides of the shafts 10 that the first rails 20 are back to each other. In the present invention, these rails 20, 22 are T-shaped bars fixed to the opposite sides of the shafts 10. Each of the rails 20, 22 have a protrusions, and the protrusions are at the same plane A.

The car 12, which has a door 24, is installed and moved in the hoistway. At a top and a bottom of the car 12, a pair of connectors 26 are provided respectively, and each of the connectors 26 are provided with a guiding device 28. In the present invention, each of the guiding devices 28 are a block with slot. The guiding devices 28 are slidly connected to the first rails 20 by the engagement of the slots of the guiding devices 28 and the protrusions of the first rails 20 that the car 12 may be moved up and down along the shafts 10 in the hoistway.

At a top of the hoistway has a machine room, in which the driving unit 14 is provided. The driving unit 14 includes a traction motor 30, a governor 32, a plurality of pulleys 34 and ropes 36. A frame 38 is provided at tops of the shafts 10 on which the traction motor 30 and governor 32 are provided. The governor 32 is connected to a driving wheel 40. The ropes 36 have opposite ends connected to the car 12 and the counterweight 16 respectively. The ropes 36 cross over the pulley 34 and the driving wheel 40 that the traction motor 30 may lift or lower the car 12 in the hoistway through the ropes 36.

The counterweight 16 is a block having about the same weight of the car 12 plus an average load of the elevator. The counterweight 16 has two guiding devices 42 at opposite sides. The same as above, the guiding devices 42 each has a slot. The counterweight 16 is located between the shafts 10 with the guiding devices 42 engaged with the second rails 22 of the shafts 10 that the counterweight 16 is driven by the ropes 36 to move along the second rails 22 in the hoistway. The counterweight 16 goes up when the traction motor 30 lowers the car 12, and the counterweight 16 goes down when the traction motor 30 lifts the car 12. It is noted that the protrusions of the first rails 20 and the second rails 22 are at the same plane A that the car 12 and the counterweight 16 may move more smoothly and stably.

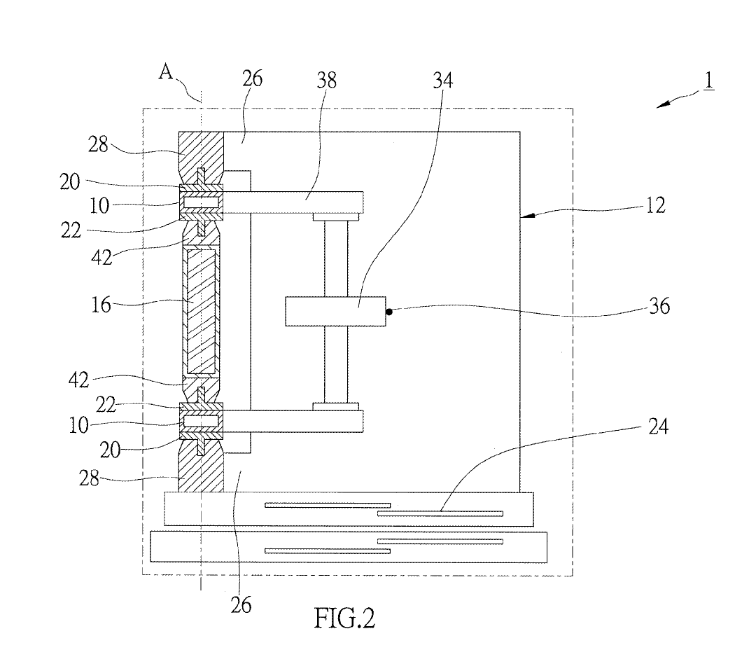

It is obviously shown in FIG. 2, the shafts 10 and the counterweight 16 are only located at a side of the car 12 that the car 12 of the present invention may have bigger area than the conventional car in the same hoistway.

In addition, the car 12 may be provided with the door 24 at the side other than the side having the shafts 10 and the counterweight 16 without having to change the structure. It may provide the car with two or three doors (not shown) at the sides without having to change the structure.

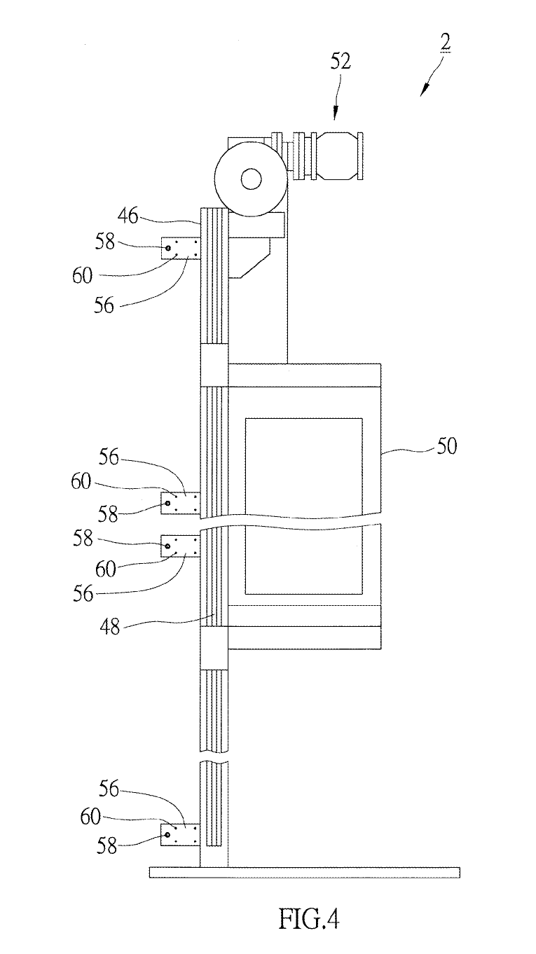

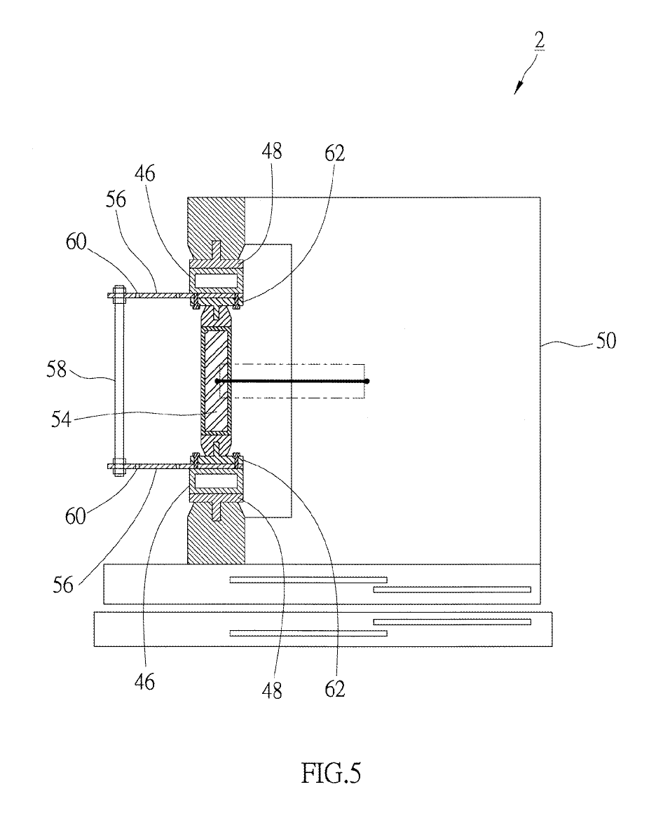

FIG. 4 and FIG. 5 show an elevator 2 of the second preferred embodiment of the present invention which is similar to the elevator 1 of the first preferred embodiment including two shafts 46 each having a first rail 48 at an outer side thereof, a car 50 engaged with the first rails 48 of the shafts 46, a driving unit 52 to lift or lower the car 50 and a counterweight 54. The main character of the elevator 2 of the second preferred embodiment is that plural pairs of frames 56 are connected to the shafts 46. The frames 56 are horizontal and have ends connected to inner sides of the shafts 46. Each pair of the frames 56 are at the same level, and a bar 58 has opposite ends connected to distal ends of each pair of the frames 56. The frames 56 have bores 60 thereon that second rails 62 may be secured on the frames 56 at different locations by bolts or other fasteners. The counterweight 54, as same as above, is engaged with the second rails 62 for movement.

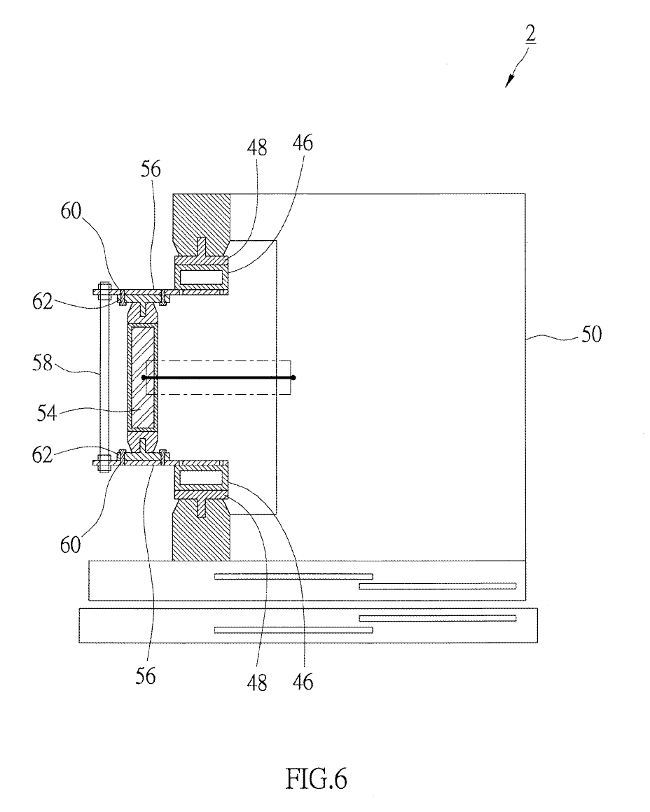

The second rails 62 are secured at the frames 56 which are located at the inner sides of the shafts 46. The function of the elevator 2 shown in FIG. 4 and FIG. 5 is the same as the elevator 1 of the first preferred embodiment. Sometime, we may need the space between the shafts for other purposes. As shown in FIG. 6, the second rails 62 may be shifted outwardly and secured to another bores 60 on the frames 56. At this time, the second rails 62 are distal to the car 50 than the first rails 48. That is, it may adjust a distance between the second rails 62 and the car 50 by securing the second rails 62 to different bores 60 of the frames 56. The bores 60 are elongated that the second rails 62 may have a fine adjustment to keep them straight. Therefore, it is more flexible for the elevator designer.

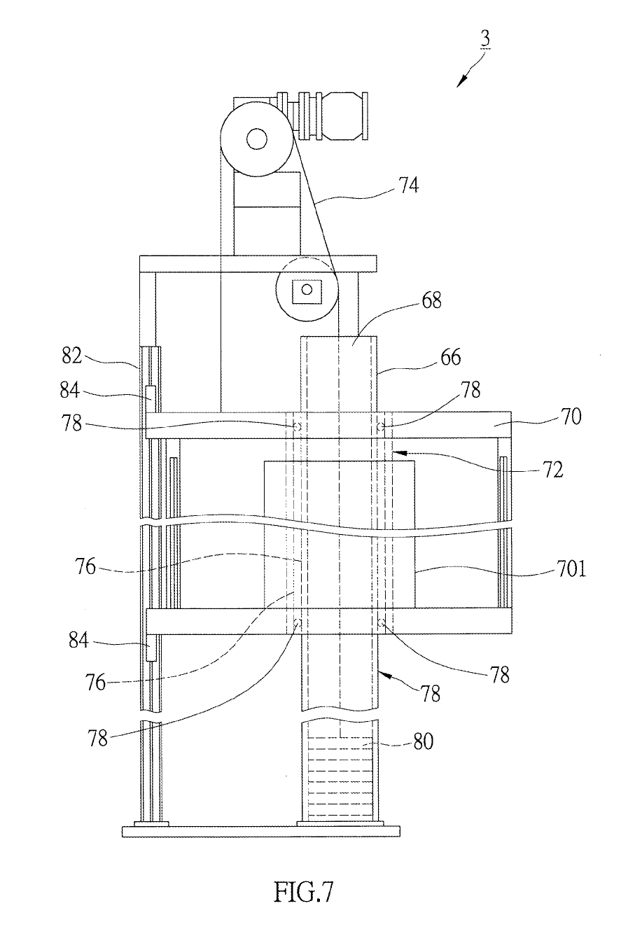

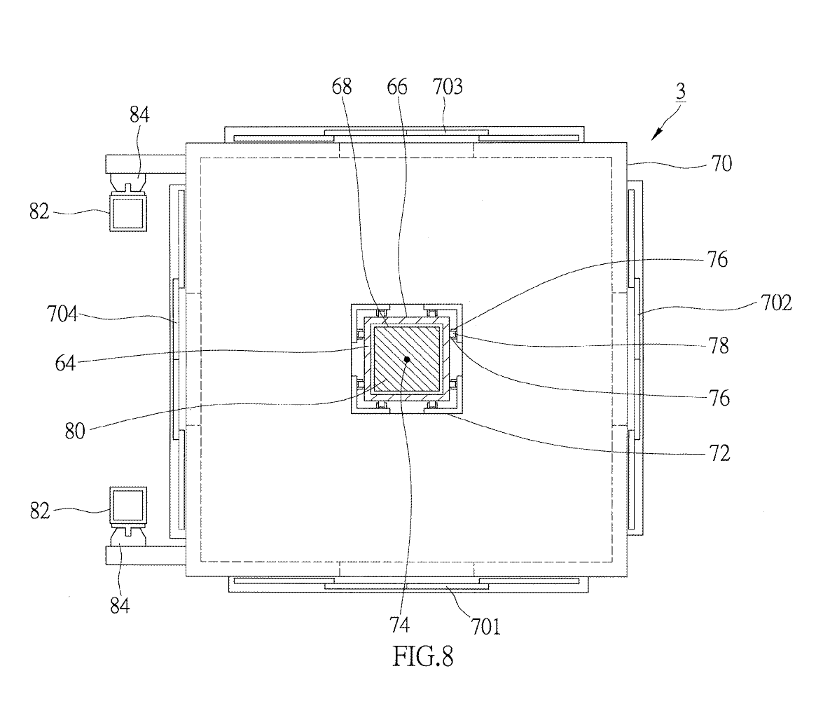

FIG. 7 and FIG. 8 show an elevator 3 of the third preferred embodiment of the present invention including a shaft 64 vertical extending at a center of a hoistway. The shaft 64 is a hollow rectangular shaft. An outer surface of the shaft forms a first rail 66, and a vertical tunnel in the shaft forms a second rail 68. A car 70 has a vertical guiding device 72 at a center thereof. The guiding device 72 is a hollow rectangular post extended from a top to a bottom of the car 70. The shaft 64 passes through the guiding device 72 of the car 70 that the car 70 may be moved up and down along the shaft 64 through ropes 74. At an inner side of the guiding device 72, a plurality pairs of walls 76 are provided and two rollers 78 are pivoted between each pair of the walls 76. The rollers 78 run on the outer surface (the first rail 66) of the shaft 64 for a smoother movement of the car 70. A counterweight 80 is received in the tunnel the shaft (the second rail 68) to be moved along the tunnel (the second rail 68) through the ropes 74.

In the hoistway, two auxiliary rails 82 are provided. The auxiliary rails 82 are outside of the car 70, and the car 70 is provided with guiding devices 84, the same as above, to be engaged with the auxiliary rails 82 that the elevator 3 of the third preferred embodiment may have a strong structure and a smooth movement.

It is obvious that the car 70 of the elevator 3 of the third preferred embodiment may be provided with four doors 701, 702, 703, 704 at four sides that people may enter or leave the elevator 3 via all directions.

In conclusion, the present invention provides the elevator with the shaft(s) to guide both of the car and the counterweight that the shaft(s) take less space in the hoistway and the hoistway will have more space for the car. As a result, the elevator of the present invention will have a greater capacity than the conventional elevator in the same hoistway. Just because the present invention has less shaft than the convention elevator that the elevator of the present invention may be built in a low cost.

The description above is a few preferred embodiments of the present invention and the equivalence of the present invention is still in the scope of claim construction of the present invention.

What is claimed is:

1. An elevator, comprising:
a pair of vertical shaft, each of which have a vertical first rail and a vertical second rail;
a car having guiding devices to be engaged with the first rails of the shafts that the car moves along the shafts;
a counterweight having guiding devices to be engaged with the second rails of the shafts that the counterweight moves along the shafts; and
a driving unit having ropes with opposite ends connected to the car and the counterweight to drive the car to move.

2. The elevator as defined in claim 1, wherein the second rails of each other that the counterweight moves between the second rails.

3. The elevator as defined in claim 1, wherein the first rail and the second rail are at opposite sides of the shaft.

4. The elevator as defined in claim 1, wherein the first rails and the second rails are at the same plane.

5. The elevator as defined in claim 1, wherein the first rail has a protrusion, and the guiding device of the car has a slot to be engaged with the protrusion of the first rail.

6. The elevator as defined in claim 1, wherein the second rail has a protrusion, and the guiding device of the counterweight has a slot to be engaged with the protrusion of the second rail.

7. The elevator as defined in claim 1, further comprising a plurality of horizontal frames having ends connected to the shafts respectively, wherein the second rails are fixed to the frames to adjust a distance between the second rails and the car.

8. The elevator as defined in claim 7, wherein each pair of the frames are located at the same level and a bar has opposite ends connected to the frames.

9. The elevator as defined in claim 7, wherein the frames has a plurality of bores to secure the second rails.

10. The elevator as defined in claim 9, wherein the bores are elongated.

11. An elevator, comprising:
a vertical shaft having a vertical first rail and a vertical second rail;
a car having a guiding device to be engaged with the first rail of the shaft that the car moves along the shaft;
a counterweight having a guiding device to be engaged with the second rail of the shaft that the counterweight moves along the shafts; and
a driving unit having ropes with opposite ends connected to the car and the counterweight to drive the car to move.

12. The elevator as defined in claim 11, wherein the shaft is a hollow shaft having an outer surface to be the first rail and a tunnel therein to be the second rail and the counterweight is received in the tunnel of the shaft.

13. The elevator as defined in claim 12, wherein the guiding device of the car is a hollow post that the shaft passes through the post.

14. The elevator as defined in claim 13, wherein the post is provided with rollers running on the outer surface of the shaft.

15. The elevator as defined in claim 14, wherein the post is provided with walls and the rollers are pivoted between the walls respectively.

16. The elevator as defined in claim 12, wherein the post is in the car and is extended from a bottom to a top of the car.

17. The elevator as defined in claim 16, wherein the car is provided with four doors at four sides thereof.

18. The elevator as defined in claim 11, further comprising a pair of auxiliary rails, and the car has guiding devices engaged with the auxiliary rails respectively.

19. The elevator as defined in claim 11, wherein the guiding device is in the car that the shaft passes through the car, and the auxiliary rails are outside of the car.
